(19) United States
(12) Patent Application Publication
(10) Pub. No.: US 2009/0240722 A1
(43) Pub. Date: Sep. 24, 2009

(54) SYSTEM FOR FORMING FAMILY TREES THROUGH NETWORK

(76) Inventors: Jack YU, Taipei City (TW); Nick LIN, Taipei City (TW)

Correspondence Address: Jack YU, 235 Chung - Ho Box 8-24, Taipei, TW

(21) Appl. No.: 12/050,168

(22) Filed: Mar. 18, 2008

(51) Int. Cl. G06F 17/30

(52) U.S. Cl. 707/102; 707/E17.01

(57) ABSTRACT

A system for forming family trees through a network comprises a user interface for receiving names of relatives and degrees of the relatives known by a user so as to form as a family tree database; wherein the user can determine whether to open this family tree database; if the family tree database is not opened, that is, no one can access to this family tree database other than user himself; after combining two different family tree databases, a combined family tree database is built; a network server for storing the family tree databases, and the combined family tree databases; and the network server having a connecting unit for combining two different family tree databases under above mentioned conditions; and a display for displaying data about the system.

### FIELD OF THE INVENTION

The present invention relates to a system for forming family trees through a network, in that the family tree is built from network, which break the obstacle of the isolation in current society. Furthermore, the family tree from the present invention provides many functions, such as research of family tree, or society research.

### BACKGROUND OF THE INVENTION

A family tree serves to record the relations of relatives and the degrees of the relatives (such as father is the first order relative and brothers are second order relative, etc.). In many traditional societies, the family trees are widely recorded and spread. However currently, people migrates greatly, it is often that members of a family are spread in many areas and they are disconnected, while the family trees must be used in many fields, such as connection of relatives, inheritance of estate, marriages, etc. Furthermore, the re-building old mansions must connect many owners which are spread in many different areas, even in foreign areas. Family trees are helpful to these work. Thus the family trees have their usages. Currently, network is widely used and thus is it possible to use the network for building family trees is main concern in the building of family trees.

In one prior art, software is developed for registering the parameters of the relatives stored. A search engine serves to search the desired data of the relative. The names and data of the relatives are classified for searching. The data can be displayed.

However the prior art discloses the software for building a family tree database, but it did not disclose to use network to build family tree databases so that people at many different areas can participate the building of the family trees.

### SUMMARY OF THE INVENTION

Accordingly, the object of the present invention is to provide a system for forming family trees through a network, in that the family tree is built from network, which breaks the obstacle of the isolation in current society. Many people in different locations, even they are not known to each other, but by the connection of the present invention, a great family tree can be built. Furthermore, the family tree from the present invention provides many functions, such as research of family tree, or society research. The present invention is also helpful to determine the order and shares of heritage. Furthermore, the present invention can provide the information for user to make decision in marriage.

To achieve above object, the present invention provides a system for forming family trees through a network, comprising: a user's interface for receiving names of relatives and degrees of the relatives known by a user so as to form as a family tree database; wherein the user can determine whether to open this family tree database; if the family tree database is not opened, that is, no one can access to this family tree database other than user himself; if the user determines to open this family tree database, the system can combine this family tree database to another family tree database at the following conditions: combining with another family tree database under the agreement of the user, or combining with another family tree database with at least one member in the family tree database is the same as another member at another family tree database; after combining two different family tree databases, a combined family tree database is built; a network server for storing the family tree databases, and the combined family tree databases; and the network server having a connecting unit for combining two different family tree databases under above mentioned conditions; and a display for displaying data about the system.

The various objects and advantages of the present invention will be more readily understood from the following detailed description when read in conjunction with the appended drawing.

### BRIEF DESCRIPTION OF THE DRAWINGS

FIG. 1 shows the system block of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

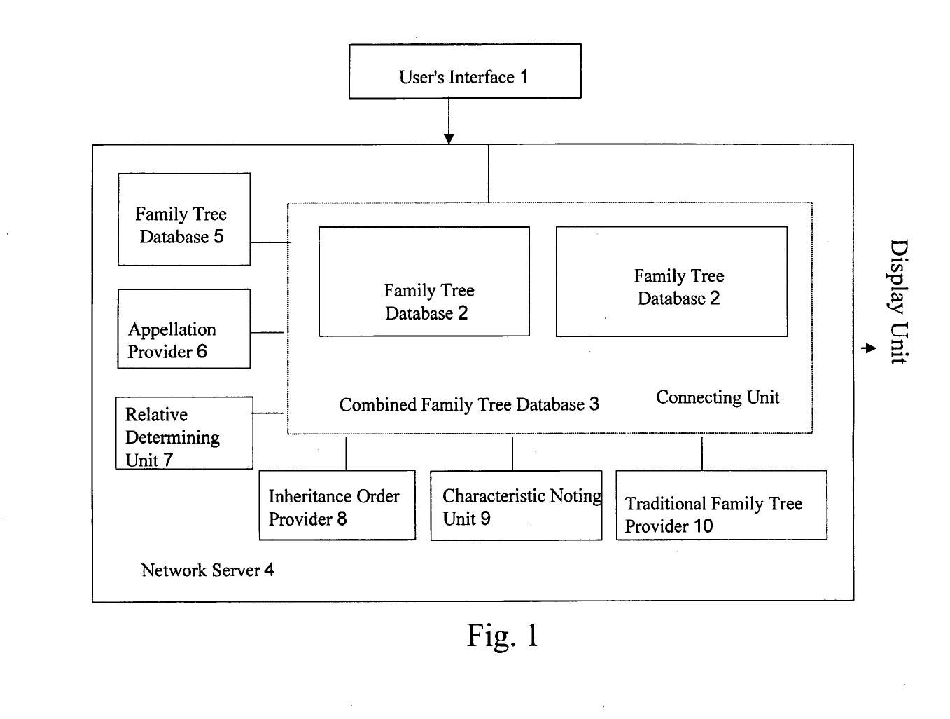

Referring to FIG. 1, a system for building a family tree comprises the following components.

A user's interface 1 serves for receiving names of relatives and degrees of the relatives known by a user so as to form as a family tree database 2. The user can determine whether to open this family tree database 2. If the family tree database 2 is not opened, that is, no one can access to this family tree database 2 other than user himself (herself). If the user determines to open this family tree database, the system can combine this family tree database to another family tree database at the following conditions: combining with another family tree database under the agree of the user, or combining with another family tree database with at least one member in the family tree database is the same as another member at another family tree database. After combining two different family tree databases, a combined family tree database 3 is formed.

A network server 4 serves to store the family tree databases, and the combined family tree databases 3. The network server 4 has a connecting unit for combining two different family tree databases under above mentioned conditions.

A display 4 serves for displaying the data about the system, such as family tree databases, relatives, degrees of relatives, etc.

In the present invention, the network server 4 device comprises a limitation unit 5 for limiting the degrees of relatives to be viewed by a user. By the limitation unit 5, the user can view the family trees only within the allowed degrees of relatives, such as the allowed degrees of relatives is from first degrees of relatives to sixth degrees of relatives. Thus the user can not view the seventh degrees of relatives.

In the present invention, the network server 4 further comprises an appellation provider 6 for providing the appellation for a relative, such as uncles, cousins, etc. Thus, as the relations of relatives are very complicated, the appellation provider can provide the appellation to the user. The result will be displayed in the display 4.

The present invention further comprises a relative determining unit 7 which provides the function of determination of relatives. For current complicated connubiality, such as companionate marriages, blended families, etc. The present invention provides the function for determining the relative relation base on the rules of the law.

The network server 4 further has an inheritance order provider 8 for providing a list of inheritance which lists the people having the right to inherit a heritage of someone and the order or priorities of the people in the action of the heritage. Furthermore, the ratio about the share of the heritage is also provided.

Moreover, the network server 4 of the present invention further provides a characteristic noting unit 9 by which a user can notes the characteristics for the relatives registered by the user. By this unit, the characteristics of the members are recorded. This is beneficial for identifying one person rather than denoting a person by only the name of the person. This is because it is very often that different persons have the same name. However in combination of different family tree databases, the characteristic noting unit 9 will prevent the combination from a wrong determination to identify one only by the name himself (or herself). Furthermore, this unit 9 also provides a function of recording the data of a relative.

The network server 4 of the present invention further provides a traditional family tree provider 10 which provides many traditional family trees (such as famous Confucius family tree, which has a register over 2500 years with a list of descendents over one hundred people). However by this connection the user can connect to his (or her) remote ancestors and then by threes remote ancestors, the family trees can further connect to other different family tree for people still existed or newly generated. This is helpful to the society understand and research.

Advantages of the present invention are that the family tree is built from network, which break the obstacle of the isolation in current society. Many people in different locations, even they are not known to each other, but by the connection of the present invention, a great family tree can be built. Furthermore, the family tree from the present invention provides many functions, such as research of family tree, or society research. The present invention also helpful to determine the order and shares of heritage. Furthermore, the present invention can provide the information for user to make decision in marriage.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A system for forming family trees through a network, comprising:
a user interface for receiving names of relatives and degrees of the relatives known by a user so as to form as a family tree database; wherein the user can determine whether to open this family tree database; if the family tree database is not opened, that is, no one can access to this family tree database other than user himself; if the user determines to open this family tree database, the system can combine this family tree database to another family tree database at the following conditions: combining with another family tree database under the agreement of the user, or combining with another family tree database with at least one member in the family tree database is the same as another member at another family tree database; after combining two different family tree databases, a combined family tree database is built;
a network server for storing the family tree databases, and the combined family tree databases; and the network server having a connecting unit for combining two different family tree databases under above mentioned conditions; and
a display for displaying data about the system.

2. The system for forming family trees through a network as claimed in claim 1, wherein the network server further includes a limitation unit for limiting the degrees of relatives to be viewed by a user; by the limitation unit, the user can view the family trees only within the allowed degrees of relatives.

3. The system for forming family trees through a network as claimed in claim 1, wherein the network server further includes an appellation provider for providing the appellation for a relative.

4. The system for forming family trees through a network as claimed in claim 1, wherein the network server further provides a relative determining unit which provides the function of determination of relatives.

5. The system for forming family trees through a network as claimed in claim 1, wherein the network server further includes an inheritance order provider for providing a list of inheritance which lists the people has the right to inherit a heritage of someone and the order or priorities of the people in the action of the heritage; and a ratio about shares of the heritage is also provided.

6. The system for forming family trees through a network as claimed in claim 1, wherein the network server further provides a characteristic noting unit by which a user can notes the characteristics for the relatives registered by the user.

7. The system for forming family trees through a network as claimed in claim 6, wherein the characteristics are at least one of nationalities, sexes, skin colors, residence addresses, identify numbers, and passport numbers.

8. The system for forming family trees through a network as claimed in claim 1, wherein the network server further provides a traditional family tree provider which provides many traditional family trees for being connected with current built new family trees.
